(19) United States
(12) Patent Application Publication
(10) Pub. No.: US 2004/0249527 A1
(43) Pub. Date: Dec. 9, 2004

(54) Vehicle information display apparatus

(76) Inventors: Yuji Tomita, Tokyo (JP); Akio Morozumi, Nagano (JP); Takashi Sunaba, Nagano (JP)

Correspondence Address: WENDEROTH, LIND & PONACK, L.L.P., 2033 K STREET N. W., SUITE 800, WASHINGTON, DC, 20006-1021, US

(21) Appl. No.: 10/819,157

(22) Filed: Apr. 7, 2004

(30) Foreign Application Priority Data
Jun. 5, 2003 (JP) 2003-160654

(51) Int. Cl. G05D 1/00

(52) U.S. Cl. 701/29

(57) ABSTRACT

An improved vehicle information display apparatus made capable of notifying vehicle information, such as a vehicle speed, an engine revolution speed or water temperature to a user instantly and continuously with a high accuracy. The apparatus includes an obtaining unit for continuously obtaining vehicle information by joining a joint connector to a vehicle diagnosing connector provided in a vehicle, a unit for processing the vehicle information obtained by the obtaining unit, and a unit for notifying the information processed by the processing unit to the user instantly and continuously. This enables the vehicle information, such as a vehicle speed, an engine revolution speed or a water temperature to be notified to the user instantly and continuously with a high accuracy.

### BACKGROUND OF THE INVENTION

1. Field of the Invention

The present invention relates to a vehicle information display apparatus adapted to continuously obtain vehicle information from a vehicle diagnosing connector provided in a vehicle, and instantly and continuously notify the vehicle information, for example, a vehicle speed, an engine revolution speed or a water temperature to a user.

2. Related Art

A vehicle, such as an automobile is generally provided in advance with a display apparatus for indicating a vehicle speed. However, there are some vehicles which do not display an engine revolution speed. Also, there are some users, for example, drivers of vehicles who feel unsatisfactory to vehicle information indicated only on the vehicle information display apparatus.

Under the circumstances, there is as a device for notifying an engine revolution speed to a driver, for example, a “Vehicular Accessory Device” [refer to JP-A-11-342810 (pages 2 to 3)] which includes, a voltage fluctuation detecting unit adapted to obtain the information on the starting of a cell motor and an engine revolution speed by monitoring the voltage fluctuation obtained from a cigar plug, a voltage value monitoring unit operatively connected to the voltage fluctuation detecting unit and adapted to store a minimum voltage by monitoring a voltage for a preset first required period of time, a display adapted to indicate a value of the minimum voltage for a predetermined period of time, an operation switching unit operatively connected to the voltage fluctuation detecting unit and adapted to be switched so that the engine revolution speed calculating unit is started after the lapse of a preset second required period of time, and a notification unit adapted to notify a maximum engine revolution speed value sent from the engine revolution speed calculating unit to the driver.

In the known techniques disclosed in JP-A-11-342810, a pulsating flow of voltage fluctuation obtained from the cigar plug is counted as a pulse current, and the counted number is converted into an engine revolution speed, which is indicated on the display apparatus.

In recent years, an automobile is obligated to mount thereon with a vehicle function diagnosing system 2 (on-board diagnostic system stage 2, OBD2) adapted to provide information on electronic control units for the purpose of monitoring all electric constituent parts that have influence upon a gas discharged from the automobile, for example, electronic control units (ECU) for an engine, a transmission or brakes.

These electronic control units for an engine, a transmission or brakes are connected together by multiplex transmission lines so that the informaion on each electronic control unit can be taken from one unit and given to another. Therefore, the information on each of the electronic control units is outputted to the vehicle diagnosing connector used in the vehicle function diagnosing system provided in a vehicle, such as an automobile.

It is known, as an apparatus utilizing such a vehicle function diagnosing system, a trouble diagnosing apparatus for vehicles provided with an electronic control apparatus capable of storing trouble data therein, and a trouble diagnosing device capable of displaying the condition of the trouble so that the order of the occurrence of the trouble is understood on the basis of the trouble data stored in the electronic control units [refer to JP-A-2003-27981 (page 2)].

In the known techniques disclosed in JP-A-2003-27981, a connector (joint connector) of a trouble diagnosing tester is joined to a vehicle-side connector, i.e. a diagonal connector (vehicle diagnosing connector so that a cause of the trouble can be identified easily. Thus, these techniques aim at reducing the vehicle inspection time and labor in a maintenance and repair factory and the user's share in expenses.

However, in the known techniques disclosed in JP-A-11-342810, the engine revolution speed is calculated by utilizing a pulsating flow of voltage fluctuation obtained from the cigar plug, so that the engine revolution speed lacks accuracy. In addition, the information other than the engine revolution speed cannot be displayed.

In the known techniques disclosed in JP-A-2003-27981, the vehicle function diagnosing system is used temporarily only when a trouble of a vehicle is diagnosed in a maintenance and repair factory, and not adapted to instantly and continuously obtain the information on the vehicle, such as a vehicle speed, an engine revolution speed or a water temperature.

Therefore, the conventional vehicle information display apparatuses have problems of necessarily improving the apparatuses so that the information on a vehicle, such as a vehicle speed, an engine revolution speed or water temperature can be notified to a user instantly and continuously with a high accuracy.

### SUMMARY OF THE INVENTION

The present invention, as a concrete unit for solving the problems encountered in the above-described related art examples, provides a vehicle information display apparatus, including a vehicle information obtaining unit adapted to join a joint connector to a vehicle diagnosing connector provided in the vehicle and obtain the information on the vehicle continuously, a processing unit adapted to process the vehicle information obtained by the information obtaining unit, and a notification unit adapted to instantly and continuously notify the information processed by the processing device to a user.

The obtaining unit may be adapted to obtain the vehicle information outputted to a K line of the vehicle diagnosing connector, or CAN.

The processing unit may be provided with a storage unit adapted to store the vehicle information and processed information therein.

The notification unit may be an image frame display unit and/or a unit for giving a warning sound.

The information displayed on the image frame may be any one kind or not smaller than two kinds of pieces of information out of a vehicle speed, an engine revolution speed, a water temperature, ignition time, injection starting time of an injector, a suction air temperature, an air flow voltage, a boost, a 02 sensor voltage, a 02 sensor voltage rear, an air/fuel ratio correction factor, a battery voltage, a throttle sensor voltage, WGV 1, WGV 2 or a trouble diagnosing code.

A cigar plug may be connected to a cigar socket provided in the vehicle to detect a voltage supplied to the cigar socket, whereby the ON-OFF of a power source is controlled.

The apparatus may render it possible to automatically set a manufacturing company of the vehicle or the kind of the vehicle.

The vehicle information display apparatus according to the present invention includes a unit for obtaining vehicle information continuously by joining a joint connector to a vehicle diagnosing connector provided in a vehicle, a unit for processing the vehicle information obtained by the obtaining unit, and a unit for notifying the information processed by the processing unit to a user instantly and continuously, this enabling vehicle information, such as the vehicle speed, engine seed or water temperature to be notified to a user instantly and continuously with a high accuracy.

### BRIEF DESCRIPTION OF THE DRAWING

FIG. 1 is a plan view schematically showing a mode of embodiment of the vehicle information display apparatus according to the present invention;

FIG. 2 is an enlarged plan view schematically showing a body of the same vehicle information display apparatus;

FIG. 3 is a schematic diagram of the construction of the same vehicle information display apparatus;

FIG. 4 is a flow chart showing a process of setting the manufacturing company of a vehicle by the same vehicle information display apparatus;

FIG. 5 is a flow chart showing a process of obtaining vehicle information from a K line of a vehicle diagnosing connector by the same vehicle information display apparatus;

FIG. 6 is a flow chart showing a process for indicating the vehicle information on an image frame of a display monitor of the same vehicle display apparatus;

FIG. 7 is an enlarged display reference diagram of a display monitor (pointer meter) of a body of the same vehicle information display apparatus; and

FIG. 8 is an enlarged display reference diagram of a display monitor (bar graph) of a body of the same vehicle information display apparatus.

### DETAILED DESCRIPTION OF PREFERRED EMBODIMENT

The present invention will now be described in detail on the basis of a concrete mode of embodiment thereof.

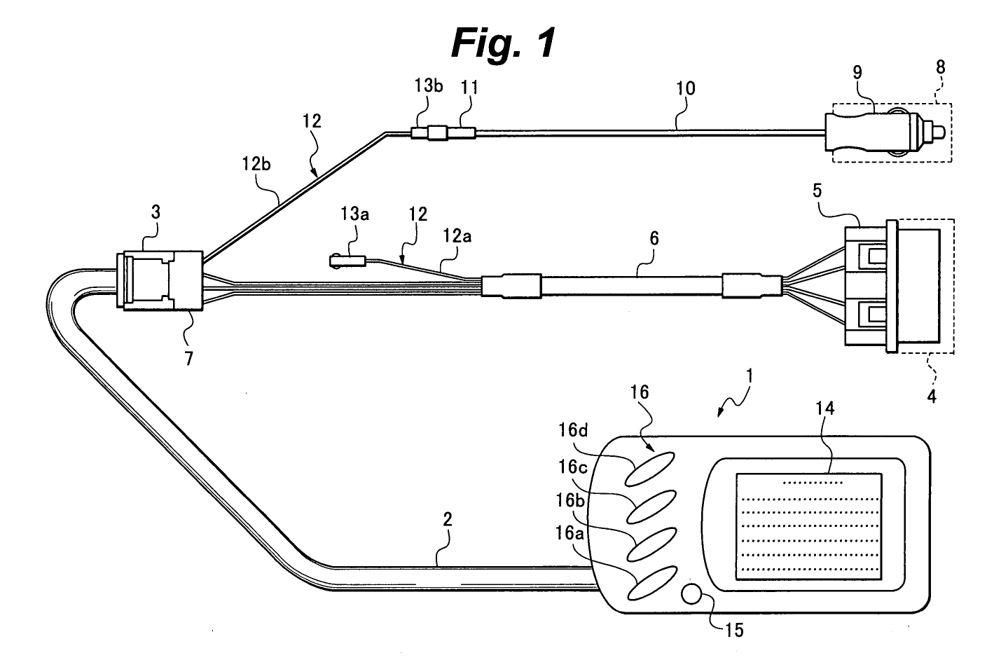

A plan view schematically showing a mode of embodiment of the vehicle information display apparatus according to the present invention will be shown in FIG. 1. A body-side harness 2 is connected to a body 1 of the vehicle information display apparatus, and a joint connector 3 is fixed to an end portion of the body-side harness 2.

A joint connector 5 opposed to and detachable with respect to a vehicle diagnosing connector 4 (diagnostic connector, and a connector corresponding to IS09141, IS014230 or JIS D5404) is connected to the vehicle diagnosing connector 4 joined to an electronic control units (ECU) provided in a motor, a transmission or brakes (which are not shown) of a vehicle, such as an automobile.

A main harness 6, for example, OBD2 (vehicle function diagnosing system 2) cable is connected to the joint connector 5, and a joint connector 7 is fixed to the other end portion of the main harness 6.

The vehicle diagnosing connector 4 and the body 1 of the vehicle information display apparatus can be electrically connected together by connecting together the joint connector 7 fixed to the main harness 6 and the joint connector 3 fixed to the body-side harness 2.

When the vehicle diagnosing connector 4 and the body 1 of the vehicle information display apparatus are thus electrically connected together, the body 1 of the vehicle information display apparatus becomes able to continuously obtain various kinds of vehicle information (diagnostic codes) outputted from the vehicle diagnosing connector 4.

The vehicle information obtained by this obtainment unit includes vehicle information outputted to the K line of the vehicle diagnosing connector 4, for example, a vehicle speed, an engine (motor) revolution speed, a water temperature, an ignition time, injector starting time, a suction air temperature, an air flow voltage, a boost, a 02 sensor voltage, a 02 sensor voltage rear, an air/fuel ratio correction factor, a battery voltage, a throttle sensor voltage, WGV1, WGV2 or a trouble code. As the vehicle information mentioned above, vehicle information outputted to the CAN (Controller Area Network) may be obtained.

A cigar plug 9 is connected to a cigar socket 8 provided in the vehicle. An igniton/accessories harness 10 (hereinafter referred to as IGN/ACC harness) is connected to the cigar plug 9, and a connecting terminal 11 is fixed to an end portion of the IGN/ACC harness.

Since the cigar plug 9 may be electrically connected to a wire of an ignition or accessories of the vehicle, the connecting of the cigar plug 9 to the cigar socket 8 is not limitabve. For example, the connecting of the IGN/ACC harness 10 electrically to the wire of the ignition or accessories directly with the cigar plug 9 omitted is also included.

The main harness 6 is formed by a bundle of a plurality of signal conductors. One ignition signal conductor 12 (which will hereinafter be referred to as an IGN signal conductor) out of these signal conductors is divided into an IGN signal conductor 12a on the side of the joint connector 5 and an IGN signal conductor 12b on the side of the joint connector 7. Connecting terminals 13a, 13b are fixed to the IGN signal conductors 12a, 12b respectively.

FIG. 1 shows the condition of the joint terminal 11 fixed to the IGN/ACC harness 10 and the joint terminal 13b fixed to the IGN signal conductor 12b on the side of the joint connector 7 both of which joint terminals are connected together.

When the accessories are turned on by an operation of an ignition key (not shown) of the vehicle, so that, for example, the electronic machines in the vehicle are turned on in this condition of the joint terminals 11, 13b thus connected together, a voltage supplied from the cigar socket 8 provided in the vehicle via the same cigar socket 8 can be detected at the body 1 of the vehicle information display apparatus.

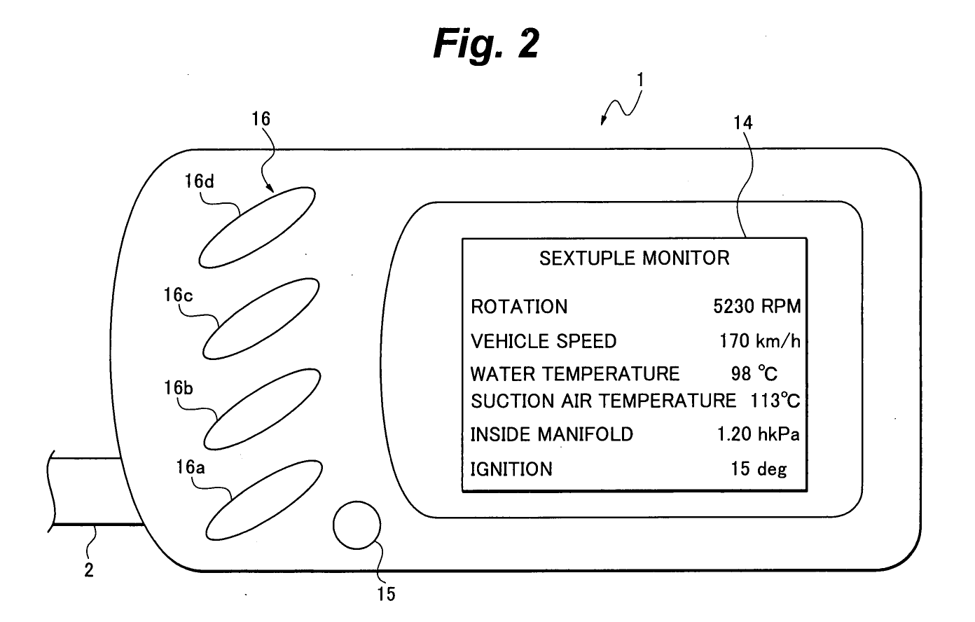

An enlarged plan of the body 1 of the vehicle information display apparatus is shown in FIG. 2. The body 1 of the vehicle information display apparatus is provided with, for example, a display monitor 14, such as a LCD adapted to indicate information on an image frame and a buzzer 15 adapted to send out a warning sound as devices for notifying information to a user of the vehicle, for example, a driver of the vehicle.

What is notified to the user by the information displayed on the image frame of the display monitor 14 is any one or not smaller than two kinds of pieces of information out of, for example, a vehicle speed, an engine (motor) speed, a water temperature, ignition time, injector starting time, a suction air temperature, an air flow voltage, a boost, a 02 sensor voltage, a 02 sensor voltage rear, an air/fuel ratio correction factor, a battery voltage, a throttle sensor voltage, WGV1, WGV2 or a trouble diagnostic code.

The notifying of the vehicle information to a user by displaying the same on the image frame may be done, for example, by using a warning lamp, such as a LED. For example, when the vehicle speed or engine revolution speed exceeds a preset level, the fact may be notified to the user by flashing the warning lamp.

The notifying of vehicle information to the user by sending out a warning sound from a buzzer 15 is done, for example, when the vehicle speed or engine revolution speed exceeds a preset level. The notifying of the vehicle information may be done either by indicating images on the display monitor 14 or by sending out a warning sound from a buzzer 15.

The body 1 of the vehicle information display apparatus is provided with operating switches 16, for example, a MENU switch 16a, an ENTER switch 16b, a DOWN switch 16c and an UP switch 16d so that the setting of the vehicle information display apparatus and the switching of the indication of the information on the image frame can be done. The apparatus may be so formed that, when the operating switch 16 is actuated, the buzzer 15 produces a buzzing sound for a short period of time.

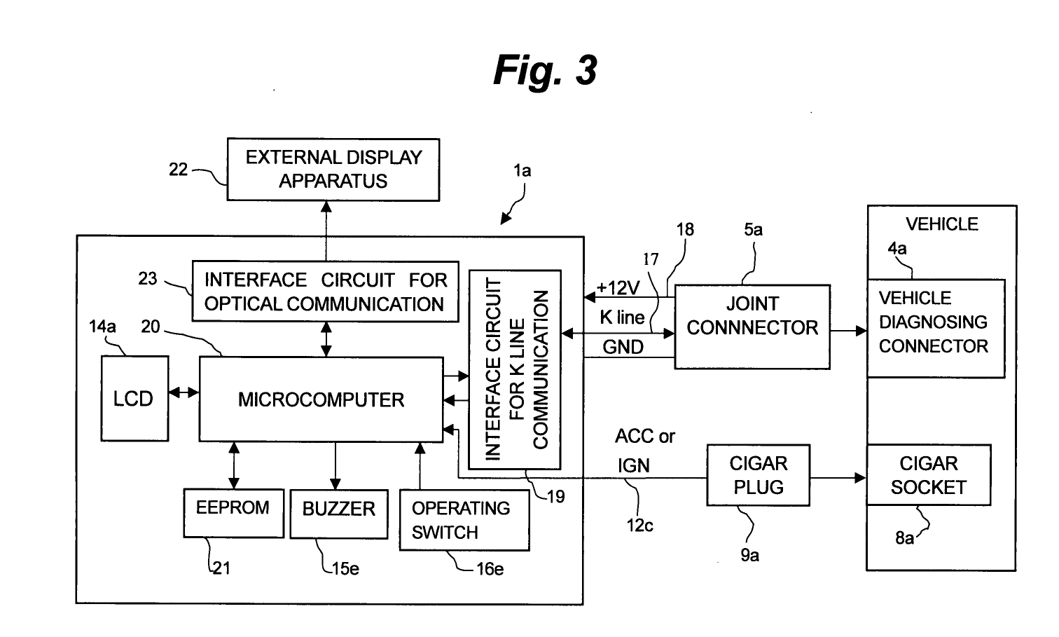

FIG. 3 schematically shows that the body 1a of the vehicle information display apparatus and the vehicle diagnosing connector 4a provided in a vehicle are connected together via the joint connector 5a, and that the body 1a of the vehicle information display apparatus and the cigar socket 8a provided in the vehicle are connected together via the cigar plug 9a.

A current of a power source 17 of a battery (not shown) provided in a vehicle is supplied from a vehicle diagnosing connector 4a to a body 1a of a vehicle information display apparatus. A method of obtaining a power source current for the body 1a of the vehicle information display apparatus is not limited to a method of receiving a current of the power source 17 supplied from the vehicle diagnosing connector 4a. For example, a method of receiving a current from a cigar socket 8a or a method of using a battery may be used.

The body 1a of the vehicle information display apparatus obtains the vehicle information outputted to a K line 18 (or CAN) of the vehicle diagnosing connector 4a via a joint connector 5a joined to the vehicle diagnosing connector 4a.

The vehicle information thus obtained is transmitted to a microcomputer 20 as a device for processing the vehicle information, via a K line-communicating interface circuit 19 of the body 1a of the vehicle information display apparatus.

In this K line-communicating interface circuit 19, the vehicle information outputted to the K line 18 is converted into a signal which the microcomputer 20 can process, for example, a UART signal.

In the microcomputer 20, the transmitted vehicle information is processed by a predetermined computation method stored in a storage unit 21. The information processed in the microcomputer 20, for example, the content of preceding displayed information, and preceding vehicle information outputted to the K line 18 may be stored as necessary in the storage unit 21. For example, an EEPROM can be used as this storage 21.

The information stored in the storage unit 21 is read by the microcomputer 20 when occasion demands. When the power source is turned off after the body 1a of the vehicle information display apparatus was used, the storage of the information executed prior to the OFF of the power source can be held in the storage unit 21. Therefore, when the power source is thereafter turned on, the information stored prior to the OFF of the power source is read into the microcomputer 20, and the information stored prior to the OFF of the power source can thereby be fed back to the vehicle diagnosing connector 4a.

As a result, the resetting of the information becomes able to be omitted by holding the information set last time by actuating the operating switch 16e. When the information obtained last time and the information obtained when the power source is turned on again are greatly different from each other, it also becomes possible to notify the fact to the user by a notification unit.

The information processed in the microcomputer 20 is notified instantly and continuously to the user of the vehicle by indicating the information on the image frame of the display monitor 14a and/or by a warning sound sent out from the buzzer 15.

In short, when, for example, the content to be notified to the user by the notification device by actuating the operating switch 16e is engine revolution speed, the engine revolution speed varying every moment is indicated instantly and continuously on the display monitor 14a. When the engine revolution speed exceeds a preset level while the engine revolution speed is kept monitored continuously, a warning sound is sent out instantly, and the fact is thereby notified to the user.

An external display unit 22 is connected to the body 1a of the vehicle information display apparatus, and the notifying of the vehicle information to the user by indicating the information on the image frame of the external display unit 22 may be made. In order to indicate the vehicle information on the image frame of the external display unit 22, for example, the information processed in the microcomputer 20 is converted into a signal, which is capable of being inputted into the external display unit 22, in the interface circuit 23 for optical communication, and the resultant signal is inputted into the external display apparatus 22.

When the ignition key (not shown) of the vehicle is actuated to cause the accessories to be turned on in the condition in which the cigar plug 9a is connected to the cigar socket 8a provided in the vehicle as mentioned above, the variation of the voltage is inputted into the microcomputer 20 via the IGN signal line 12c, and the variation of the voltage can be detected in the microcomputer 20.

When the voltage supplied to the cigar socket 8a is detected in the microcomputer 20, the power source for the body 1a of the vehicle information display apparatus is turned on. When the voltage becomes impossible to be detected in the microcomputer 20, the power source for the body 1a of the vehicle information display apparatus is turned off.

Since the voltage supplied to the cigar socket 8a is thus rendered detectable in the microcomputer 20, the ON-OFF of the power source for the body 1a of the vehicle information display apparatus can be controlled in accordance with an operation of the ignition key of the vehicle.

It is a matter of course that, for example, the body 1a of the vehicle information display apparatus be provided with a power source switch (not shown), which is operated so as to render it possible to switch the ON-OFF of the power source.

The methods of supplying a power source current to the microcomputer 20 when the power source for the body 1a of the vehicle information display apparatus is off include, for example, a method of supplying a required power source current to the microcomputer 20 from a battery therefor. Also, a method of supplying a power source current from a power source 17 of a battery with a mode set to a sleeve mode in a low consumption current condition may be used.

Furthermore, when the operating switch 16e is actuated, a method of turning on the power source for the body 1a of the vehicle information display apparatus, and turning off the same after the lapse of a predetermined period of time may be used.

In a certain vehicle in which, only when, for example, an ignition key thereof is operated to cause the accessories to be turned on, a current of a power source 17 is supplied from a vehicle diagnosing connector 4a, it is unnecessary to connect a cigar plug 9a to a cigar socket 8a. In this case, the ON-OFF of the power source for a body 1a of a vehicle information display apparatus may be controlled in accordance with an operation of the ignition key of the vehicle by connecting together as shown in FIG. 1a joint terminal 13a fixed to an IGN signal line 12a on the side of a joint connector 5 and a joint terminal 13b fixed to an IGN signal line 12b on the side of a joint connector 7.

When the IGN signal line 12 is thus divided into two, the ON-OFF of the power source for the body 1a of the vehicle information display apparatus can be controlled in any case in accordance with an operation of the ignition key. However, it is not always necessary to divide the IGN signal line 12 into two. For example, when the IGN signal line 12a and IGN signal line 12b are connected together, the IGN signal line 12 may be formed to one signal line. Also, a body-side harness 2 may be connected to a vehicle diagnosing connector 4 with a main harness 6 shown in FIG. 1 omitted.

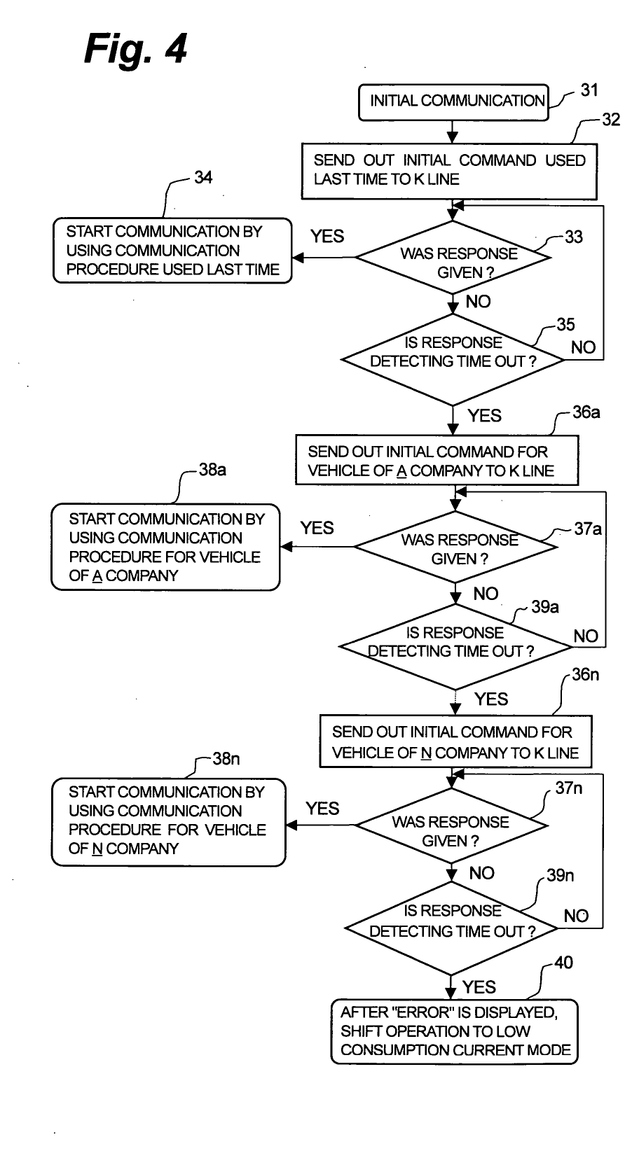

The operation of the vehicle information display apparatus will now be described by using FIGS. 4 to 6.

FIG. 4 shows a flow chart of a process for automatically setting the manufacturing company of a vehicle (kind of a vehicle) by making communication between the microcomputer 20 of the body 1a of the vehicle information display apparatus shown in FIG. 3 and the vehicle diagnosing connector 4a provided in the vehicle, on the basis of the information stored in the storage unit 21 in the body 1a. The process for setting the kind of the vehicle is identical with that of setting the manufacturing company thereof shown in FIG. 4. Since the description is duplicated, the description of the process of setting the kind of the vehicle will be omitted.

First, an initial communication 31 for ascertaining the connection between the body 1a of the vehicle information display apparatus and the vehicle diagnosing connector 4a is made. The information stored last time in the K line 18 (CAN also serves the purpose) of the vehicle diagnosing connector 4a is thereafter sent out 32 from the body 1a of the vehicle information display apparatus 1a.

A response from the K line 18 of the vehicle diagnosing connector 4a is detected 33. When a response is given, communication starts 34 on the basis of a communication procedure set last time. When a response is not given, the detection 33 of response is carried out repeatedly 35 for a predetermined period of time.

When a response is not given even though a predetermined period of time elapses, the operation is shifted to a new setting condition, and a response is detected 37a by sending 36a an initial command for a vehicle of an A company to the K line 18. When a response is given after the initial command for a vehicle of the A company is sent out, the vehicle is judged to be a vehicle of the A company, and communication is started 38a on the basis of the communication procedure for the vehicle of the A company.

When the kind of the vehicle is set as a vehicle of the A company, for example, the vehicle information which the vehicle of the A company can output to the K line 18 is automatically judged, and the information which can be notified to the user can be displayed on the image frame on the basis of the vehicle information. When the kind of the vehicle is set, the coefficients of each vehicle can be set automatically.

The sending 36a of the initial command for the vehicle of the A company is done repeatedly 39a for a predetermined period of time. When a response is not given even though a predetermined period of time elapses, the procedure for sending an initial command for a vehicle of a B company, an initial command for a vehicle of a C company up to an initial command, which is stored in the storage device 21, for, for example, an N company is carried out repeatedly in the same manner as that of sending the initial command for the vehicle of the A company.

Accordingly, the sending 36n of the initial command for the vehicle of the N company is also done 39n repeatedly for a predetermined period of time. When a response is not given even though a predetermined period of time elapses, the manufacturing company of the vehicle cannot be set. Therefore, “error” is displayed, and the operation is shifted 40 to a low consumption current mode.

Thus, the manufacturing company of the vehicle or the kind of the vehicle can be automatically set by only connecting the joint connector 5a of the body 1a of the vehicle information display apparatus to the vehicle diagnosing connector 4a. Therefore, the user's setting of the manufacturing company of the vehicle or the kind of the vehicle manually is not needed, and the setting operation is carried out simply. Moreover, an erroneous setting operation does not occur.

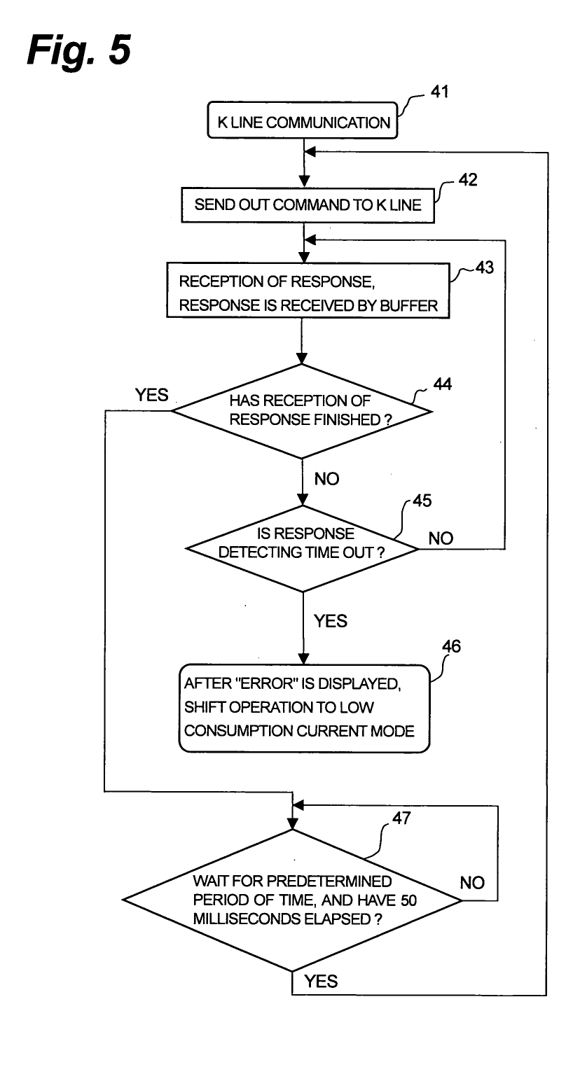

FIG. 5 is a flow chart of a procedure for obtaining vehicle information from the K line 18 of the vehicle diagnosing connector 4a into the microcomputer 20 in the body 1a of the vehicle information display apparatus after the manufacturing company of the vehicle is set.

When the content to be notified to the K line is set by actuating the operating switch 16a in the vehicle information display apparatus, communication is made 41 by the microcomputer 20 of the body 1a of the apparatus with the K line 18 of the vehicle diagnosing connector 4a, and a command is sent out 42 so as to give instructions by transmitting the information for displaying the content to be notified to the K line.

The vehicle diagnosing connector 4a outputs vehicle information, the content of which is notified to the K line 18, in accordance with the instructions of the command, and the vehicle information is obtained 43 by a buffer (not shown) or the microcomputer 20.

The vehicle information-obtained 43 condition is ascertained 44, and, when the obtainment of the information is not finished, the information obtaining operation is carried out repeatedly 45 for a predetermined period of time. When the information cannot be obtained even though a predetermined period of time elapses, “error” is displayed, and the operation is shifted 46 to a low consumption mode.

When the obtainment 43 of the vehicle information is finished, the operation is left on standby 47 for, for example, a predetermined period of time (50 milliseconds according to FIG. 5), and the subsequent vehicle information varying every moment is obtained. When these processes of the sending out 42 of K line command through the waiting 47 for a subsequent operation for a predetermined period of time are carried out repeatedly, the vehicle information can be obtained continuously.

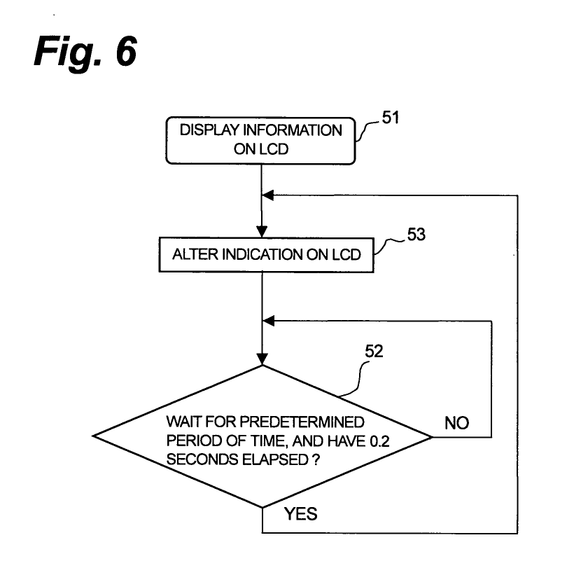

FIG. 6 shows a flow chart of a procedure for indicating information on the image frame of the display monitor 14a of FIG. 3. When a display instruction signal is outputted from the microcomputer 20 in the body 1a of the vehicle information display apparatus to the display monitor 14a, the display monitor 14a indicates 51 thereon the content of the vehicle information set by actuating the operating switch 16e.

The display monitor 14a retains 52 the indication 51 of the content of the vehicle information for a predetermined period of time (0.2 seconds according to FIG. 6). After the predetermined period of time elapses, the content of the vehicle information is altered to that of subsequent vehicle information outputted from the microcomputer 20, and the altered information is displayed 53.

When a procedure, in which the displaying 51 of the content of vehicle information to the altering of the content of the information to that of subsequent vehicle information and the displaying 53 of the same is carried out repeatedly, the information processed by the microcomputer 20 which constitutes a processing unit can be notified to the user instantly and continuously.

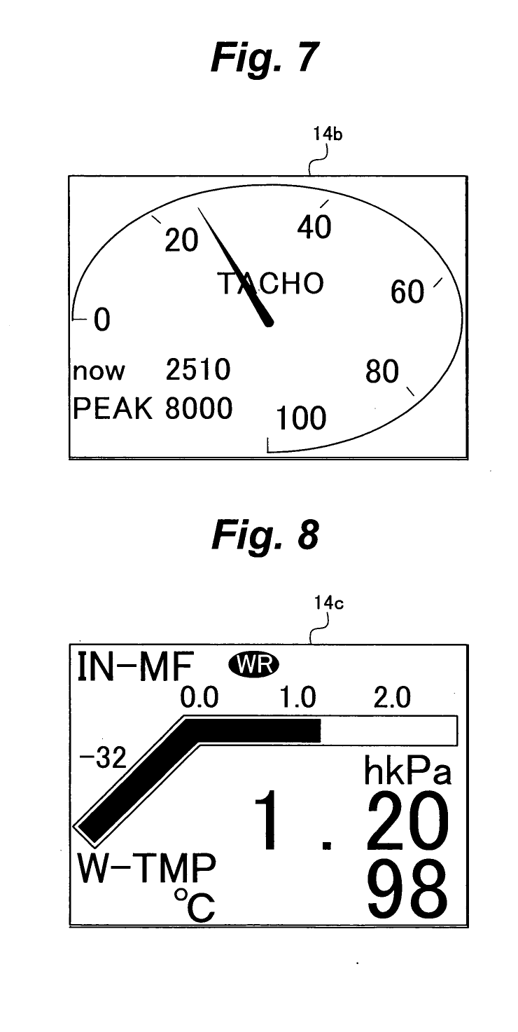

FIG. 7 is an enlarged display reference drawing of a display monitor 14b, which constitutes a notification unit for carrying out an image frame displaying operation in the body 1 of the vehicle information display apparatus of FIG. 1. In FIG. 7, an engine revolution speed is indicated as an example of information image-frame displayed by a pointer like that on a pointer type meter.

The employment a pointer type meter for indicating information thereon besides the employment of a numerical display on which information is indicated thereon by figures as shown in FIG. 7 enables the vehicle users visibility of the information to be improved.

FIG. 8 is a display reference drawing on which an engine revolution speed is indicated as another example of the indication of information on an image frame of the display monitor 14c, by a bar graph instead of numerals on the pointer type meter of FIG. 7. Thus, even the same vehicle information can be indicated in a plurality of kinds of display modes.

The engine revolution speed can be indicated in a plurality of kinds of display modes, for example, on an elliptic meter, a triple meter (displaying three kinds of vehicle information at once) or a sextuple meter (displaying six kinds of vehicle information at once) besides the pointer type meter and bar graph meter.

When the vehicle information obtained continuously from the vehicle diagnosing connector 4 provided in the vehicle is processed and notified to the user in this manner, various kinds of vehicle information, such as the vehicle speed, engine revolution speed or water temperature can be notified instantly and continuously to the user, and the accuracy of the information notified to the user can be heightened.

The vehicle information display apparatus according to the present invention described above includes a unit for obtaining vehicle information continuously by joining a joint connector to a vehicle diagnosing connector provided in the vehicle, a unit for processing the vehicle information obtained by the obtainment unit, and a unit for notifying the information processed by the processing unit to the user instantly and continuously. This enables an excellent effect to be displayed, i.e., vehicle information, such as the vehicle speed, engine revolution speed or water temperature to be notified to the user instantly and continuously with a high accuracy.

What is claimed is:

1. Avehicle information display apparatus comprising:
a unit for obtaining vehicle information continuously by joining a joint connector to a vehicle diagnosing connector provided in a vehicle,
a unit for processing the vehicle information obtained by the obtaining unit, and
a unit for notifying the information, which is processed by the processing unit, instantly and continuously to a user.

2. Avehicle information display apparatus according to claim 1, wherein:
the obtaining unit is adapted to obtain the vehicle information outputted to a K line of the vehicle diagnosing connector, or CAN.

3. Avehicle information display apparatus according to claim 1, wherein:
the processing unit is provided with a storage unit adapted to store the vehicle information and processed information therein.

4. Avehicle information display apparatus according to claim 1, wherein:
the notification unit is an image frame display unit and/or a unit for giving a warning sound.

5. A vehicle information display apparatus according to claim 4, Wherein the information displayed on the image frame is any one kind or not smaller than two kinds of pieces of information out of a vehicle speed, an engine revolution speed, a water temperature, ignition time, injection starting time of an injector, a suction air temperature, an air flow voltage, a boost, a 02 sensor voltage, a 02 sensor voltage rear, an air/fuel ratio correction factor, a battery voltage, a throttle sensor voltage, WGV 1, WGV 2 or a trouble diagnosing code.

6. A vehicle information display apparatus according to claim 1, wherein:
a cigar plug is connected to a cigar socket provided in the vehicle, a voltage supplied to the cigar socket being detected, whereby the ON-OFF of a power source is controlled.

7. A vehicle information display apparatus according to claim 1, wherein:
the apparatus renders it possible to automatically set a manufacturing company of the vehicle or the kind of the vehicle.
